(19) United States
(12) Patent Application Publication
(10) Pub. No.: US 2003/0140145 A1
(43) Pub. Date: Jul. 24, 2003

(54) Communication system and method therein

(76) Inventors: Niclas Lindberg, Hagersten (SE); Goran Eriksson, Sundbyberg (SE); Aimo Tuoriniemi, Espoo (FI)

Correspondence Address: NIXON & VANDERHYE P.C., 8th Floor, 1100 North Glebe Road, Arlington, VA, 22201-4714, US

(21) Appl. No.: 09/742,282

(22) Filed: Dec. 22, 2000

(30) Foreign Application Priority Data
Dec. 22, 1999 (EP) 99850209.0

(51) Int. Cl. G06F 15/16

(52) U.S. Cl. 709/227; 709/204

(57) ABSTRACT

A communication system comprises user end points, a network, and an intermediate end point, the user end points being connected to the network via different link-layers. A session is invitated by a first user with a second user by means of an invitation signal from the first user over the network. The invitation is received by an intermediate point in the network, which allocates an invitation identity to the invitation. The intermediate point then forwards the invitation together with the invitation identity to the second user over the network. The second user receives the information about the invitation together with the invitation identity, and selects end point and/or access configuration for responding to the session invitation. The second user then responds to the request with the selected end point and/or access configuration by appending the invitation identity. The intermediate point associates the response with said invitation signal and establishes the session.

### TECHNICAL FIELD

The present invention relates to a method in a communication system for establishing a session between users, especially in a communication system comprising user end points, access networks and a backbone network between the access networks, the user end points being connected to the network by means of different link-layer technologies.

### BACKGROUND ART

Traditionally, there are different networks for different kinds of communication services, such as telephony or data communication. The different services have different requirements on the networks and the associated equipment. Therefore, the networks are traditionally dedicated for given services, which are used by given kinds of terminals.

ISDN (Integrated Services Digital Network) is an example of a network for fixed telephony. Mobile telephony has access to the fixed telephony networks and the communication between a fixed telephone and a mobile phone takes place over the fixed telephony networks. This also applies to mobile to mobile communication over GSM (Global Service for Mobile Transmission), or other cellular technologies, such as AMPS (Advanced Mobile Phone System) or PDT (Pacific Digital Telephony). Both fixed telephony and mobile telephony are used for speech communication by means of telephones as terminals. Mobile telephony might also include data services, such as SMS (Short Message Services).

Generally, transmission of data takes place through data networks, that consist of interconnected computers, such as PCs (Personal Computers) as terminals. Data communication technologies are evolving and expanding at an unparallelled rate. The growth of the demand for Internet access and intranet services continues to fuel rapid technical adaptation by both implementers and developers. An internetwork is a collection of individual networks connected by intermediate networking devices (so called nodes), that function as a single large network. The computers in a data network can be interconnected by different kinds of technologies, such as Ethernet, Token Ring or FDDI (Fiber Distributed Data Interface). Local Area Networks (LANs) are networks covering relatively small geographical areas, while Wide Area Networks (WANs) interconnect LANs.

The transmission part of the communication network can be divided into trunk connections and access connections. The trunk network, consisting of multiplexing channels with varying capacity, connects the nodes to each other. The access network consists of connections between the nodes and the user terminals.

The information needs transport services for the transmission, which can be maintained by cables, fibers or radio links. The transmission is performed by means of different link-layer technologies, which can be radio links using e.g. cellular technologies like NMT, GSM, or Wireless techniques, like Wireless LAN, Bluetooth techniques or Satellite, or they can be fixed cable technologies using data links like Ethernet or Token Ring or telephony links, like ISDN.

The Open System Interconnection (OSI) reference model describes how information from a software application in one computer moves through a network medium to a software application in another computer. The OSI reference model is a conceptual model of seven layers, each specifying particular network functions. The seven layers of the OSI model are called Application, Presentation, Session, Transport, Network, Data Link and Physical. The upper layers deal with application issues and generally are implemented only in software. The highest layer is closest to the end user. The lower layers handle data transport issues. The physical layer and data link layer are implemented in hardware and software. The other lower layers generally are implemented only in software. The lowest layer, the physical layer, is closest to the physical network medium (e.g. the network cables) and is responsible for placing the information on the medium. Information being transferred from a software application in a computer to a software application in another computer must pass through each of the OSI layers. A given layer in the OSI layers generally communicates with three other OSI layers; the layer directly above it, the layer directly below it, and its corresponding layer in other networked computer systems. For example, the data link-layer in one system communicates with the data link-layer in another system.

The physical layer defines the electrical, mechanical, procedural and functional specifications for the physical link between communicating network systems.

The data link layer provides reliable transmission of data across a physical network link. Different data link layer specifications define different network and protocol characteristics, including physical addressing, network topology, and flow control. Physical addressing, as opposed to network addressing, defines how devices are addressed at the data link layer. Network topology consists of the data link layer specifications that often define how devices are to be physically connected, such as by a bus (like in Ethernet) or a ring (like Token Ring).

The network layer provides routing and related functions that enable multiple data links to be combined into an internet work. The Internet Protocol (IP) is a network layer protocol that contains addressing information and some control information for routing. Along with the Transmission Control Protocol (TCP), IP represents the heart of the Internet protocols.

Transport layer functions typically include flow control, multiplexing, and virtual circuit management. An example of a protocol handled by this layer is the Transmission Control Protocol (TCP).

The session layer establishes, manages, and terminates communication sessions between presentation layer entities. The presentation layer provides a variety of coding and conversion functions that are applied to application layer data. Common data representation formats enable the interchange of application data between different types of computer systems.

Today, when a telephone call or a data connection is established in networks designed for given dedicated services, the users are often bound to specified network and devices. Thus, when alerting a user in e.g. traditional telephony networks about an incoming communication request, the alerting signal is connected to a certain device, e.g. a POTS (Plain Old Telephony System) telephone. Furthermore, this device is connected to the network via a specific link layer technology. If the user is not available, there will be no reply and the request may be forwarded to another device or to an answering machine having another telephone number.

The exchange of connecting information between the user of the service and some node, normally a local station in the network, is called signalling. The user of the service controls the network by the choice of service and the called subscriber. For a common telephone call, the control means that the user lifts the telephone handset and enters the number of the person to be called after having received the coupling tone. The network requires the ringing signal to be immediately handled. The nodes in the network have to be ready for the signalling. The handling is somewhat different depending on service and connection type (circuit switching, packet switching). Distributed additional services and mobile telephony introduce extra requirements for establishment, control and termination of the connection.

Existing alerting solutions in IP networks are e.g. the IETF standard SIMS in which there is a user preference information in the network indicating on which terminal or end point the user shall be alerted, and what to do in case of no reply. If the user is available on several accesses with associated terminals the network will either poll access by access, or broadcast, i.e. transmit the invitation to a set of possible end points/terminals.

The development is leading towards a more integrated use of the networks, towards interactive wide band services by using multiple link access technologies i.e. a convergence of data and telecom applications. Several subscriber categories with different requirements on quality, functionality, availability, quantity, prices etc. result in the technical solutions in the networks being results of interaction between the requirements on the subscribers, the available technology and the price of that. The available transparence and bandwidth for the different services will increase and availability and terminal mobility will be important.

For example, in a future home, there will, in addition to telephony and TV, commonly be used other kinds of technology, like data communication through an IP-network with an increased amount of available services compared with today. A multimedia equipment will be standard equipment in the homes. Also within companies, internal data and multimedia communications set up new requirements on the technology and devices used.

With the introduction of Internet and IP technology based multimedia services, the number of possible ways to communicate will increase considerably. A user may have many communication devices, e.g. a mobile, a laptop, a handheld computer, and/or a dedicated mixed voice terminal. These devices can themselves work on different link-layer technologies. Also, communication sessions may be of different types such as text chat, speech, plain video telephony and 3D video reality communication.

As mobile telephony and data communication increase, and as the users may have different technologies and equipment available, and as mobility will be increasingly apparent, more and more requirements are set on the capacity, [symbol] , security and flexibility of e.g. signalling, especially in future integrated service systems. Flexible solutions for establishment, maintenance and termination of sessions in future scenarios, where integrated services are [symbol] across the network, are therefore needed.

The object of the invention is to provide more flexible solutions for establishment of sessions between users and to increase the possibility to select the desired technology in said establishment, i.e. user adjustment (terminal) and/or accesses used for the session

A more detailed object of the invention is to provide solutions for establishment of sessions to be used in future multimedia scenarios described above.

### SUMMARY

The invention relates to a method in a communication system for establishing sessions between one or more users, the communication system comprising user end points (terminals), a network, and an intermediate end point, the user end points (terminals) being connected to the network via different link-layers, and comprises the following steps. A session by a first user with a second user is invited by means of an invitation signal from the first user over the network. The invitation is forwarded by an intermediate point in the network, an invitation identity being optionally allocated to the invitation. The intermediate point forwards the invitation together with the invitation identity, to the second user over the network, informing the second use about the invitation. The second user selects the end point and/or access configuration accesses for responding to the session invitation, and responds to the request with selected end point and/or access configuration by appending the invitation identity. The intermediate point associates the response with said invitation signal and establishes the session. The selected end point and/or access configuration is used as the continued establishment and session. By “end-point” or “terminal” is meant any configuration of equipment used to access the network and convey information from and to the user over the network to other “end-points” and “users”.

The invention also relates to a communication system comprising means for performing the method of the invention.

Advantageous embodiments of the invention are as follows.

To transfer a session from one terminal to another, information about the session (session identifier, type of session, etc) needs to be sent to the other terminal. For this purpose a terminal-to-terminal protocol is used.

The mechanism whereby incoming session identifier and information about incoming session and user preferred link-layer technology to be used for the session in question, is transferred from one terminal to the other terminal, may be in the form of a terminal-to-terminal protocol.

The identity allocated can be a RANDOM number or a tag or some other commonly used identity. The intermediate point usually forwards the invitation in accordance with user preference data defining how the invitation shall be forwarded to the second user. The user preference data defines the end point and/or access configuration with which invitations to the second user shall be forwarded. The second user is informed about the invitation together with the invitation identity by means of e.g. a ringing signal, a buzz, a flash, or by E-mail.

The second user selects the end point, terminal, and/or access configuration for responding to the session invitation on the basis of the available end points and link-layer and on the basis of the art of the invited session. The end point, terminal, selected by the second user is exemplified by but not limited to a fixed telephone, a mobile phone, a PC, a multimedia desktop, a laptop, or an end point, terminal, belonging to a LAN of the second user. The access configuration selected by the second user may be cellular, Ethernet, Token Ring, FDDI, Wireless LAN, Satellite, Bluetooth etc.

The session may be of any type, exemplified by, but not limited to, real time text chat, audio (speech), videotelephony, streaming video, virtual 3D communication and gaming.

The timers in the session establishment protocols are adjusted to allow for the time required for the possible change of end point and/or access configuration. The first user can also be informed about the possible change of end point and/or access configuration to allow for the time required for the change.

In the invention, a user is alerted about an incoming call by letting the user select how to respond. The control of the service with respect to the responding method is thus not in the network, but rather in the end point(s).

The possibility to select the wait of responding is especially important in a situation where the user has one or several end points or terminals to select between, and one end point or terminal might even have access to the network over multiple link-layer technologies simultaneously, e.g. cellular technologies or fixed technologies. The user can by means of the invention use the desired terminal or end point and access configuration for responding. The decision to use a certain terminal or end point might for example be based on the requested session and the requirements for this session.

If the calling party invites the user for a demanding, i.e. requiring high bandwidth access, video conference session, the called part can select a terminal and link layer technology fulfilling the requirements for such a session. If, in contrast, the called user does not have the required equipment or if the called user for some other reason wants to change the kind of session, it is possible in accordance with the invention for the called party to select another terminal for this particular session, thus reducing the session to e.g. real-time text only. The invention also provides solutions to inform the calling party about the change or to allow the extra time required for the change. If the calling part can accept the change of session, the new kind of session can be established. The described situations might occur in future communication systems where session invitations to a called party are made via an intermediate point in the network that handles the invitations. The invitation can be performed with some user address or the like. This is in contrast to the network based user preference solution of prior art in which the response method is dependent on the invitation method. In the prior art solution, there was e.g. used a telephone number causing a ringing signal in a telephone, which telephone and its link layer technology was used by the called part for responding. Thus, in the present invention, the alerting signal is separated from the called user's establishment of the session.

The alerting signalling is done using a generic alerting mechanism independently of service, in which the session invitation is uniquely identified. This identification is used when the called user responds to the invitation, using the preferred device and associated mail/session control mechanism and link-layer technology. The invitation identity was, if necessary, generated by the intermediate point for the alerting invitation signal, and is unique for the request.

The intermediate point of the invention is called Multiple Access Session Handler (MASH), e.g. a server, via which the invitation signals are sent and by which they are handled in a way according to the invention. The invitation identity was appended to the invitation sent to the called end point(s) in a way according to user preference.

There is a possibility to use prior art mechanisms to achieve the same but that prior art is not applicable to all situations, making it necessary to and a “session identifier” in the MASH under such circumstances.

The invention is applicable in situations, wherein a user has more than one terminal, so called end points for communication, exemplified by but not limited to a fixed telephone, a mobile phone, a PC, a laptop, a hand-held computer etc. The user might in the future even have a local LAN of different devices, in which each terminal is referred to as an end point. The preference may indicate, for example that the user wishes to be alerted on his mobile phone or on his PC, or even a microphone belonging to some of the user's terminals.

To allow for the extra time required for the change, the user shall have enough time to react on the alerting, decide whether to respond on the request using the same terminal used for the alerting, or whether to change to another. Therefore, the timers in the session establishment protocols which decide the time, at which the request is given up, or at which it is transferred to an answer machine if no answer is received, should be increased when necessary. Another possibility to allow for the extra time required for the change is to send a message to the caller, who then becomes conscious about the change and the need of extra time.

### DRAWINGS

Embodiments of the invention will now be described more closely below with reference to the accompanying drawings, on which

FIG. 1 is a block diagram illustrating a communication system wherein the invention may be used, and

FIG. 2 is a flow diagram indicating principles of the invention,

FIG. 3 is another flow diagram, used in connection with a pseudo code

FIG. 4 is still another flow diagram supplementing the flow diagram of FIG. 3.

### DETAILED DESCRIPTION

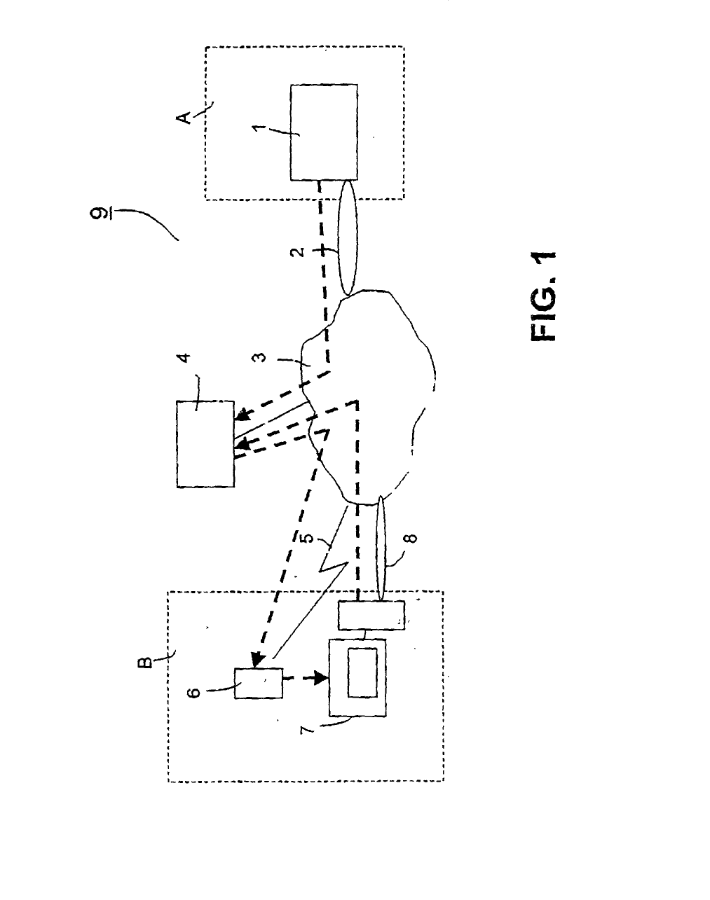

In FIG. 1 a communications system 9 comprises user end points/terminals 1, 6, 7, physically interconnected by a backbone network 3 and thereby forming a common address domain. A user A, also identified as A-user below, makes an invitation for a session to a user B, also identified as B-user below. Bounds of the A-user and B-user respectively, are indicated by areas defined by dotted lines.

A Multiple Access Session Handler (MASH) 4 is also connected to the network 3. The MASH 4 is a server or host, such as an IP-host, acting as a contact point for all users wishing to establish a session with the B-user. The main task of the server 4 is to act as a connection between communicating parties. The MASH 4 keeps data for the manner in which the B-user wishes incoming traffic to be handled. The signal paths of the invitation from the A-user to MASH 4 and from there to the B-user, as well as the response of the B-user are indicated by dotted arrows.

User preference data cover the choice of end point/terminal and access configuration to be used at first hand. This decision is based on information exemplified by, but not limited to:

(a) the required session, e.g. real time text, only voice, or voice and real time video, voice and streaming video, voice and office tools, Virtual Reality (VR) gaming,

(b) which end points/terminals and link-layer technologies the B-user has, in other words how the B-user can be reached, examplified but not limited to via cellular access to a mobile phone, via fixed access to a telephone or to a PC or with Bluetooth from wall to terminal, etc., the cost, and

(c) how it is stated in the user preference data of B in MASH 4 that the first try to reach user B shall take place.

In addition to route the request in accordance with the wishes of the end user, the server 4 associates a unique identity to the request, such as a random number or a tag. This identity makes it possible for the MASH 4 to associate the response with this request also if the response comes from another access, e.g. a cellular response to a fixed access technology request.

If the A-user sends an invitation via MASH 4 to the B-user by using a given link-layer technology and the B-user wants to answer the invitation with another access technology/terminal end point, it might take some time for the B-user to change terminal/access or both. As the originating A-side necessarily is not conscious about the change being made by the B-user, the waiting time of the A-user might need to be extended compared to conventional waiting times in connection with alerting. According to one aspect of the invention, timers handling waiting times in the A-user's terminal may be adapted in accordance with the time needed. The MASH 4 can e.g. adapt its own timer to make a decision at a given time when there is “no reply”. Alternatively, or additionally, it can generate a message to the A-side to prevent the timer at the A-user's terminal from timing out in case of an ongoing change on the B-side. Also, a message to the A-user can be generated by A user's terminal.

In FIG. 1, a user A terminal 1 is connected to the network 3 via any layer technology link 2, which might be for example cellular technologies or Ethernet, Wireless LAN, Satellite, a virtual reality room etc. The terminal 1 can be connected by more than one link-layer technology to the network, indicated by the link 2 being illustrated as two lines in FIG. 1. Another user B has a mobile phone 6 as well as a PC 7 connected to the network 3. The mobile phone 6 is connected via a radio link access technology 5 to the network 3. The radio link access technology might be for example GSM or UMTS or any other radio access technology. The PC 7 is connected to the network 3 via e.g. a fixed access technology link 8, such as cable, by Ethernet or Token Ring, Wireless LAN etc. In the same way as for the terminal 1 of the A-user, PC 7 might be connected by means of more than one link layer technology to the network, and therefore the link 8 is indicated by two lines.

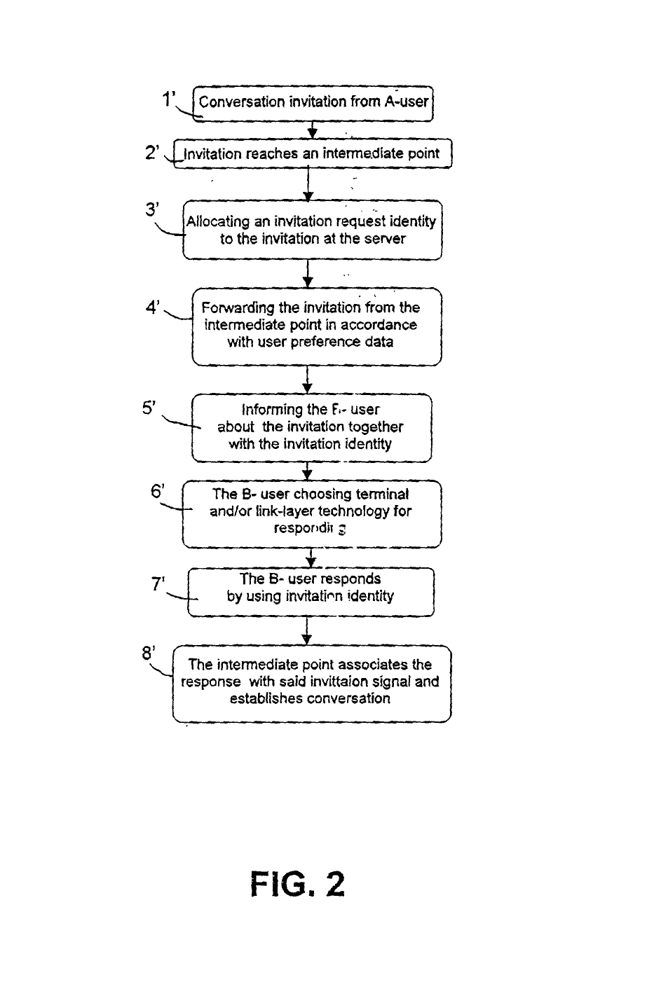

Referring now to the flow diagram of FIG. 2 in connection with the block diagram of FIG. 1, the flow starts by the A-user in step 1′ initiating (inviting) a session by means of an invitation signal from terminal 1 to the B-user. This is performed by the A-user entering the B-user's address, which can be a telephone number, an E-mail address or the like. The session invitation may be real time text, audio, audio and text, voice and streaming video, voice and real time video, voice and office tools, VR gaming.

In step 2′ the invitation signal is received by an intermediate point, such as a MASH 4, via the link 2 of terminal 1 and the network 3.

In step 3′ the MASH 4 allocates an invitation identity to the invitation.

In step 4′ MASH 4 then forwards the invitation together with user preference data. These user preference data define how the invitation shall be forwarded to the second user, which may take the form of defining the end point and/or link-layer technology by which transfer of invitations to the second user shall be performed.

In step 5′ the B-user is informed about the invitation together with the invitation identity. This can e.g. be performed by means of a ringing signal, a buzz, a flash, or by E-mail.

In this case, it may be assumed that the B-user wants the mobile phone 6 to be used via cellular access. Therefore, in step 5′ the invitation is forwarded to the mobile phone 6 via the radio link 5 together with the invitation identity allocated to the invitation in step 3.

In step 6′ the B-user selects terminal and/or link layer technology for responding to the session invitation. This choice may be made on the basis of available end points and link-layer technology, and preferably on the basis of the art of the invited session. The end point may furthermore be, as exemplified but not limited to, in the form of a fixed telephone, a mobile phone, a PC, a multimedia desktop, a lap top, or an end point belonging to a LAN of the second user. The link-layer technology selected may i.a. be cellular, Ethernet, Token ring, FDDI, Wireless LAN satellite, Bluetooth.

It can now be assumed that user B wishes to respond by using a PC 7 over a fixed access 8 instead of the mobile 6 and responds to the invitation by using the PC in step 6′ and providing the invitation identity in the response.

The invitation identity and session information can be transferred from device to device by the user itself, be stored on a smart card in the mobile and be transferred to the PC by placing the card in the PC. It can also be transferred by the mobile on the user's command. The invitation identity can also be transferred to the PC by means of a terminal to terminal protocol, e.g. transported over a Bluetooth link.

In step 7 the second user responds to the request with selected end point and/or link-layer technology by appending the invitation identity.

The response is sent via the fixed access 8 over the network 3 and to the MASH 4.

In step 8′ the intermediate point 4 associates the response with the invitation signal and establishes the session. The selected end point and/or link-layer technology is used in the continued establishment and session.

The server associates the response with the previous invitation in step 8′, and forwards the response to user A. The fixed access 8 and access 2 is used in the continued communication.

During the process of performing the above described steps, timers in session establishment protocols may be adjusted to allow for the time required for possible change of end point and/or link layer technology. The first user may also be informed about possible change of end point and/or link-layer technology to allow for the time required for the change.

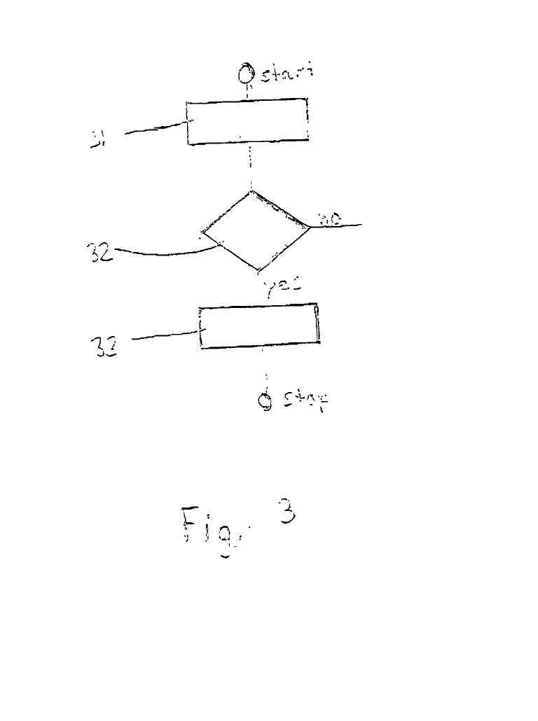

There will now be described in simplified pseudo code, and with reference to the flow diagram of FIG. 3, how to implement key parts of a mechanism allowing a user to change access and/or terminal used to establish a communication session. More particularly, FIG. 3 indicates the overall flow for the mechanism, showing behaviour of user and user equipments, sometimes referred to as “terminals” or “mobiles”.

In FIG. 3 block 31 generally represents indication of an incoming session and presentation to a user, e.g. supposed to be user B dealt with earlier. Block 32 indicates user choice of whether to change access and/or terminal or not. If “no”, then standard solution applies and the flow is stopped. If “yes”, the flow proceeds to block 33, that represents that the session, or parts of it, is transferred to another access and/or terminal. The session establishment continues. Blocks 31, 32 and 33 correspond to respective sections of the pseudo code.

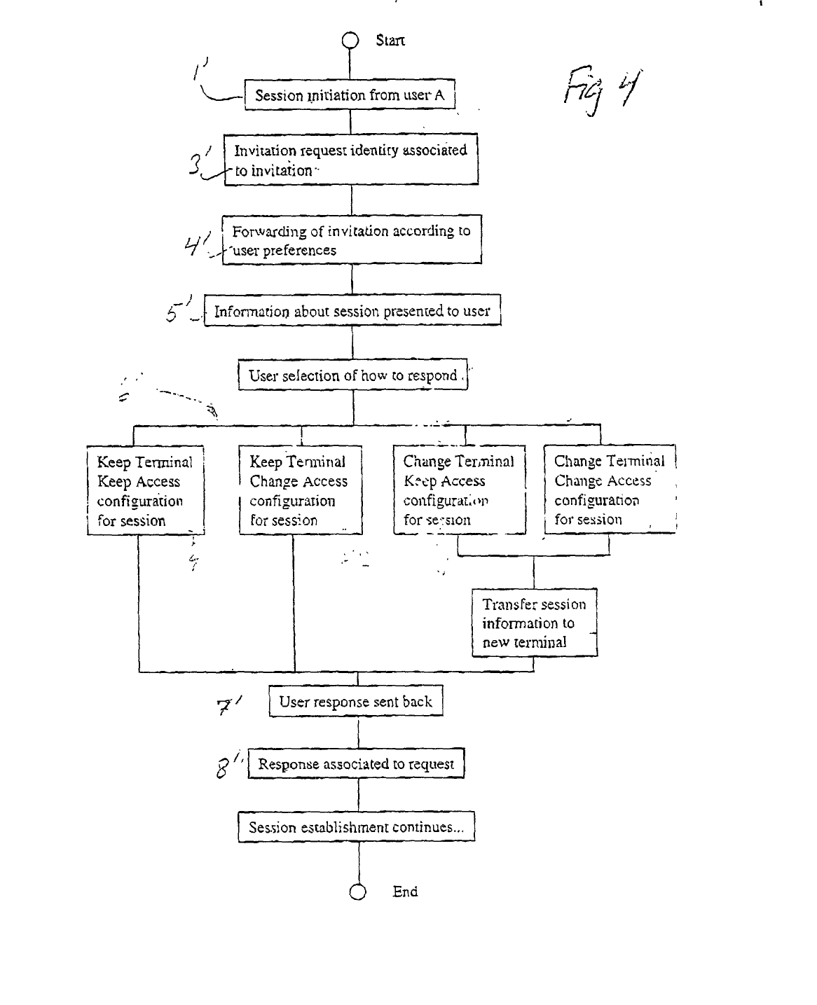

FIG. 4 is a flow diagram corresponding to the one of FIG. 1 but including details indicating the contents of blocks 31-33. To indicate the similarity with the steps used in FIG. 1, similar reference characters as in FIG. 1 are used in FIG. 4. In FIG. 4 steps 1′-5′ illustrate steps performed in block 31 of FIG. 3. Step 6′ in FIG. 4 includes substeps 41-45. Step 33 in FIG. 3 includes substeps 7′ and 8′ in FIG. 4.

In FIG. 4

step 41 indicates the choice of keeping terminal and access configuration for session,

step 42 indicates the choice of keeping terminal and changing access configuration for session,

step 43 indicates the choice of changing terminal and keeping access configuration for session,

step 44 indicates the choice of changing terminal and access configuration for session.

In case of receiving an invitation request if any of steps 43 or 44 prevail, session information will be transferred to new terminal.

The pseudo code starts with the following status: User B has two different equipments, terminals Adam and Xerxes, which are connected to a network via at least two different access types, examplified by but not limited to UMTS and Wireless LAN. An agent in the network is used which has been configured to route incoming sessions towards terminal Adam using access network UMTS as default.

Event: A session invitation arrives in terminal Adam:

Terminal Adam:

incoming Session (sessionIdentifier, sessionInformation)

{

alert User ()
{ring signa1, flash screen,
print session information screen()
-from “N.N”
typeOfSession ”. . . .
-incoming access UMTS”
{
transferQuestion ToUser()
{
print “Do You wanna transfer session?
print “You can transfer to:

Access:
-Wireless LAN
Terminal:
-Xerxes

Select by tapping on screen”
}
catch screen event switch on (userChoice)
{

case “keep access and terminal”:

continueSession(standard) ;/standard from here

/on.

break;

case “change access and termina1”

“totalTransfer(targetAccess WLAN,

targetTerminal Xerxes)”;

break;

case “keep access, change terminal”: /Not described

change Terminal(targetTermina1 Xerxes)”;
break;

case “keep terminal, change access” /Not described

“changeaccess(newAccessInfo)“;

break;

}End switch (userChoice-

}/End of IncomingSession
totalTransfer/targetAccess, targetTerminal)

{

sendProgressIndicationToCaller();
transferSession(targetTerminal)

{

print “Transferring session to. ..”;
Xerxes- >receiveSession(sessionIdentifier,

sessionInformation.
targetAccess);

};

}/End totalTransfer

Terminal Xerxes:
receiveSession(sessionIdentifier, sessionInformation,

targetAccess)

{

print “Receiving session...from...”;
resumeSessionEstablishment(); /End of main branch.

}/End receiveSession

1. A method in a communication system for establishing a session between two or more users (A, B), the communication system comprising user end points (1,6,7), a network (3), and an intermediate end point (4), the user end points (1,6,7) being able to be connected to the network (3) by means of desired ones of access configurations, comprising the steps of
a) initiating (1′) a session by a first user (A) with a second user (B) by sending an invitation request signal from the first user (A) over the network (3),
b) the intermediate point (4) receiving the request, and
b1) associating an invitation identity to the request,
b2) forwarding the request together with the invitation identity to the second user (B) over the network
c) the second user (B) selecting end point and/or at least on access configuration for responding to the session invitation request, and
c1) responding to the request with selected end point and/or access configuration by appending the invitation identity,
d) the intermediate point (4) associating the response with said request signal and establishing the session.

2. A method according to claim 1, characterized by providing the identity allocated in step b1) as a RANDOM number or a tag.

3. A method according to claim 1 or 2, characterized by the intermediate point (4) forwarding the invitation in accordance with user preference data defining how the invitation shall be forwarded to the second user (B).

4. A method according to claim 3, characterized by providing the user preference data to define an end point and/or access configuration by which invitations to the second user shall be forwarded.

5. A method according to any of claims 1-4, characterized by informing the second user about the invitation together with the invitation identity by means of a ringing signal, a buzz, a flash, or by E-mail.

6. A method according to any of claims 1-5, characterized by the second user selecting the end point and/or access configuration for responding to the session invitation on the basis of available end points and access configuration.

7. A method according to claim 6 characterized by the second user selecting end point and/or access configuration for responding to the session invitation based on the kind of the invited session.

8. A method according to any of claims 1-7, characterized by using as end point by the second user a fixed telephone, a mobile phone, a PC, a multimedia desktop, a lap top, or an end point belonging to a LAN of the second user.

9. A method according to any of claims 1-7, characterized by selecting by the second user the access configuration to be cellular, Ethernet, Token Ring, FDDI, Wireless LAN, Satellite, Bluetooth etc.

10. A method according to any of claims 1-9, characterized by providing the session invitation in step a) as real time text, audio, audio and text, voice and streaming video, voice and real time video, voice and office tools or VR gaming.

11. A method according to any of claims 1-10, characterized by adjusting timers in session establishment protocols to allow for the time required for the possible change of end point and/or access configuration.

12. A method according to any of claims 1-11, characterized by informing the first user about a possible change of end point and/or access configuration to allow for the time required for the change.

13. A communication system comprising user end points (1,6,7), a network (3), and an intermediate end point (4), the user end points (1,6,7) being able to be connected to the network (3) by means of desired ones of available link-layer technologies, characterized by
a) means for inviting (1′) a session by a first user (A) with a second user (B) by sending an invitation request from the first user (A) over the network (3),
b) means at the intermediate point (4) for receiving the request, associating an invitation identity to the request and forwarding the request together with the invitation identity to the second user (B) over the network
c) means for allowing the second user (B) to select end point and/or access configuration for responding to the session invitation request, and responding to the request with selected end point and/or access configuration by appending the invitation identity,
d) means at the intermediate point (4) associating the response with said request signal and establishing the session.

14. A system according to claim 13, characterized by the allocated identity being a RANDOM number or a tag.

15. A system according to claim 13 or 14, characterized by means at the intermediate point (4) for forwarding the invitation in accordance with user preference data defining how the invitation shall be forwarded to the second user (B).

16. A system according to claim 13, characterized by the user preference data defining an end point and/or access configuration by which invitations to the second user shall be forwarded.

17. A system according to any of claims 13-16, characterized by means for informing the second user about the invitation together with the invitation identity in the form of a ringing signal, a buzz, a flash, or by E-mail.

18. A system according to any of claims 13-17, characterized by means for allowing the second user to select end point and/or access configuration for responding to the session invitation in the form of available end points and access configuration.

19. A system according to claim 18 characterized by means for allowing the second user to select end point and/or access configuration for responding to the session invitation based on the kind of the invited session.

20. A system according to any of claims 13-19, characterized in that the end point of the second user is a fixed telephone, a mobile phone, a PC, a multimedia desktop, a lap top, or an end point belonging to a LAN of the second user.

21. A system according to any of claims 13-19, characterized in that the access configuration used by the second user is cellular, Ethernet, Token Ring, FDDI, Wireless LAN, Satellite, Bluetooth etc.

22. A system according to any of claims 13-21, characterized in that the session invitation is in the form of real time text, audio, audio and text, voice and streaming video, voice and real time video, voice and office tools or VR gaming.

23. A system according to any of claims 13-22, characterized by means for adjusting timers in session establishment protocols to allow for the time required for the possible change of end point and/or access configuration.

24. A method according to any of claims 13-23, characterized by means for informing the first user about a possible change of end point and/or access configuration to allow for the time required for the change.

25. A method in a communication system for enabling establishment of a session between two or more users (A, B), the communication system comprising user end points (1,6,7), a network (3), and an intermediate end point (4), the user end points (1,6,7) being able to access the network (3) by means of desired ones of available link-layer technologies, said establishment comprising the steps of
a) initiating (1′ ) a session by a first user (A) to a second user (B) by means of sending an invitation request identity from the first user (A) via the network (3) to the second user (B),
b) the intermediate point (4) receiving the request, and
b1) associating an invitation identity to the request (3′),
b2) forwarding (4′) the request together with the invitation identity to the second user (B) over the network (3),
characterized by
I) enabling the second user (B)
c) to select between more than one terminals for response,
d) to select access configuration for session,
II) enabling the second user (B′ to respond (7′,8′) to the request with selected terminal and access configuration.

26. A method according to claim 25, characterized by also enabling the second user in step I) to append a received invitation identity to selected terminal, to be also included with the response in step II).

27. A method according to claim 25 or 26, characterized by enabling the second user (B), in case of receiving an invitation request, to select between the steps of
A) keeping terminal and access configuration for session,
B) keeping terminal and changing access configuration for session,
C) changing terminal and keeping access configuration for session,
D) changing terminal and access configuration for session.

28. A method according to claim 27 characterized by enabling the second user (B) in case of receiving an invitation request of any of steps C) or D) prevail, to transfer session information to new terminal.
